(19) United States
(12) Patent Application Publication
(10) Pub. No.: US 2020/0140338 A1
(43) Pub. Date: May 7, 2020

(54) Shaped Ceramic Abrasive Particle and Method for Producing a Shaped Ceramic Abrasive Particle

(71) Applicant: Robert Bosch GmbH, Stuttgart (DE)

(72) Inventors: Moritz Oldenkotte, Lauf (DE); Andreas Harzer, Schwieberdingen (DE); Georg Hejtmann, Mundelsheim (DE); Jiri Misak, Dübendorf (CH); Petra Stedile, Esslingen (DE); Stefan Fuenfschilling, Öhningen (DE)

(21) Appl. No.: 16/609,494

(22) PCT Filed: Apr. 25, 2018
(86) PCT No.: PCT/EP2018/060598

§ 371 Date: Oct. 30, 2019

(30) Foreign Application Priority Data
May 2, 2017 (DE) 10 2017 207 322.5

(51) Int. Cl. C04B 35/111; C09K 3/14; C04B 35/119

(52) U.S. Cl. CPC C04B 35/1115; C09K 3/1409; C04B 35/119; C04B 2235/94; C04B 2235/786; C04B 2235/785; C04B 2235/3208; C04B 2235/3229; C04B 2235/3201; C04B 2235/3217; C04B 2235/3244; C04B 2235/3225; C04B 2235/3206; C04B 2235/3272

(57) ABSTRACT

A shaped ceramic abrasive particle based on alpha-Al₂O₃ contains a proportion of 5% to 30% by weight of ZrO₂. The alpha-Al₂O₃ has a medium crystallite size of 0.5 μm to 3 μm and the ZrO₂ has a medium crystallite size of 0.25 μm to 8 μm.

The invention relates to a shaped ceramic abrasive particle, an abrasive article and also a process for producing a shaped ceramic abrasive particle.

### PRIOR ART

Shaped ceramic abrasive particles based on alpha-Al₂O₃ (alpha-aluminum oxide) are known from the prior art. Shaped abrasive particles are abrasive particles which have a defined shape and a defined size. The abrasive particles are given their defined shape and defined size by a defined shaping process. Thus, for example, various advantageous geometries for ceramic abrasive particles are described in WO 2014/020075 A1. Furthermore, unshaped or irregularly shaped abrasive particles which are also referred to as broken abrasive particles are known from the prior art. The advantage of shaped ceramic abrasive particles is their higher abrasive performance compared to unshaped or irregularly shaped abrasive particles.

Two methods, which are likewise described in WO 2014/020075 A1, are, inter alia, known from the prior art for producing shaped ceramic abrasive particles. Alpha-Al₂O₃ is known from the prior art as starting material for producing shaped ceramic abrasive particles. If alpha-Al₂O₃ is used as starting material, the so-called slip process is particularly suitable for producing the abrasive particles. The use of precursors of alpha-Al₂O₃ which are converted into alpha-Al₂O₃ only during production of the abrasive particles as starting material for the production process is also known from the prior art. Examples of suitable precursors are the aluminum oxide hydroxides boehmite (gamma-AlO (OH)) and diasphore (alpha-AlO (OH)) and also the aluminum orthohydroxides gibbsite (gamma-Al(OH)₃) and bayerite (alpha-Al(OH)₃). In order to produce the abrasive particles from these precursors, use is made of the so-called sol-gel process which produces abrasive particles having a very fine microstructure.

There is comprehensive literature describing shaped and partially shaped sol-gel abrasive particles. The influence of ZrO₂ (zirconium oxide) in sol-gel abrasive particles has also already been examined many times. However, the starting material, alpha-Al₂O₃ or precursor of alpha-Al₂O₃, and the production process, sol-gel process or slip process, result in difference in the behavior of the shaped ceramic abrasive particles produced therefrom.

### Disclosure of the Invention

The invention proceeds from a shaped ceramic abrasive particle based on alpha-Al₂O₃ (alpha-aluminum oxide). According to the invention, the shaped ceramic abrasive particle based on alpha-Al₂O₃ contains a proportion of ZrO₂ (zirconium oxide) of from 5% by weight to 30% by weight, based on the total weight of the shaped ceramic abrasive particle. Here, the alpha-Al₂O₃ has an average crystallite size of from 0.5 μm to 3 preferably from 0.6 μm to 2 and the ZrO₂ has an average crystallite size of from 0.25 μm to 8 μm, preferably from 0.3 μm to 1.5 μm. In particular, the ZrO₂ is present in a proportion of from 10% by weight to 25% by weight, very particularly preferably from 15% by weight to 22% by weight.

It has been found that an increased proportion of ZrO₂ has an advantageous effect on the abrasive performance of abrasive articles which are provided with the abrasive particles of the invention. It is presumed that a continuous, microcrystalline degradation of the abrasive particles, which continually exposes fresh and sharp cutting edges, is achieved by means of the increased proportion of ZrO₂. An increased proportion of ZrO₂ could be associated with an increased number of weak points in the microstructure of the abrasive particles, which weak points have a positive effect on the abrasive properties of the abrasive particles. An abrasive particle comprising a proportion of alpha-Al₂O₃ and ZrO₂ is also referred to as two-phase abrasive particle.

For the purposes of the present invention, a shaped abrasive particle is understood to mean an abrasive particle which has a defined geometry. A shaped abrasive particle of defined geometry has a defined three-dimensional shape of defined size. The defined shape of defined size is obtained by means of a defined shaping process in the production of the abrasive particle. The defined geometry of the shaped abrasive particle should be reproducible. The shaped abrasive particle should be able to be produced repeatedly and in a targeted manner in the desired defined geometry. A shaped abrasive particle is in particular not a broken or partly broken abrasive particle which can be produced by comminution, in particular crushing.

Possible defined three-dimensional shapes are, in particular, geometric bodies which have two or more faces, one or more edges and one or more corners and/or points. One or more faces of the geometric bodies can be flat or curved. A curved surface can be concave or convex. One or more edges and/or one or more corners and/or one or more points can be sharp or rounded. One or more edges can have a chamfer. Examples of geometric bodies which are suitable for shaped abrasive particles are polyhedra, for example tetrahedra, pentahedra, hexahedra and others. As an alternative to polyhedra, rotational bodies, for example cones, cylinders and others, are also suitable for shaped abrasive particles. The geometric body of the shaped abrasive particle can be, in particular, a prism, a pyramid, a cylinder or a cone.

Here, the shaped abrasive particle has at least one base area which can be polygonal, for example triangular or quadrilateral, or not angular or else curved, for example round or oval. In the case of a base area having a plurality of corners, one or more side edges can be straight or curved. The geometric body also has, in particular, at least one side face. If the ceramic abrasive particle has at least one base area, at least one side face and at least one point, then it can have the shape of a cone. The geometric body can, in particular, have a base area and a plurality of side faces and also at least one point. Such an abrasive particle can have the shape of a pyramid. The at least one side face can form an outer surface.

As an alternative or in addition, the geometric body of the shaped abrasive particle can have at least one top surface which can be polygonal, for example triangular or quadrilateral, or not angular or else curved, for example round or oval. In the case of a top surface having a plurality of corners, one or more side edges can be straight or curved. The at least one top surface and the at least one base area can have the same geometric shape or different geometric shapes. The top surface and the base area can be arranged essentially parallel to one another. However, they can also be arranged at an angle to one another. The area occupied by the base area and the top surface can be essentially the same size or be of different size.

The at least one top surface is joined to the base area by at least one side face. The at least one side face here can form an outer surface between the base area and the top surface. If the base area and the top surface are formed respectively by a polygon having a number n of corners, the shaped abrasive particle can, for example, have n side faces. The geometric body can have the shape of a prism having a base area and a top surface and also a plurality of side faces. The geometric body can also have the shape of a cylinder having a base area and a top surface and also a side face. Furthermore, the geometric body can also have the shape of a frustum of a pyramid having a base area and a top surface and also a plurality of side faces. Furthermore, the geometric body can also have the shape of a frustum of a cone having a base area and a top surface and also a side face. The at least one base area and/or top surface can, for example, be formed by an equilateral and equal-angled polygon, in particular an equilateral and equal-angled triangle or square. As an alternative, the at least one base area can also be formed by a polygon having different lengths of sides. Furthermore, straight or slanted geometric bodies are suitable. Thus, the shaped abrasive particle can be, for example, a straight or slanted prism, a straight or slanted pyramid, a straight or slanted cylinder or a straight or slanted cone.

If the geometric body of the shaped abrasive particle has at least one base area, at least one top surface and one or more side faces, the body of the abrasive particle preferably has a flat shape. A flat geometric body is considered to be a body whose at least one base area and/or top surface has an extension, in particular maximum extension, which is greater by a multiple than an extension, in particular maximum extension, between the base area and the top surface along the one or more side faces. The extension of the base area and/or top surface can be, for example, defined by a length of a side edge of the base area and/or top surface. The extension between the base area and the top surface along a side face can be defined by a thickness of the body. Thus, the ratio of the extension of the base area and/or top surface to the extension between base area and top surface of the geometric body can be, for example, in a range from 2 to 10, in particular in a range from 2 to 5. Thus, for example, the ratio of side edge length to thickness of the geometric body is from 2 to 10, in particular from 2 to 5.

The shaped abrasive particle of defined geometry can also be formed by any three-dimensional shape which can be produced reproducibly. For the purposes of the present invention, the term any three-dimensional reproducible shape is intended to mean a shape in which a plurality of faces in free form together form a three-dimensional body.

In one embodiment, the defined three-dimensional shape of the ceramic abrasive particle can be a regular three-sided straight prism. The ceramic abrasive particle in this case has a base area and a top surface which are each formed by three side edges of equal length. Here, the base area and the top surface have substantially the same size. The base area and the top surface are arranged essentially parallel to one another. The base area and the top surface are separated from one another by three essentially equal side faces which form an outer surface of the prism. The regular three-sided straight prism has, in particular, a flat shape. The ratio of side edge length to thickness of the prism is, for example, in a range from 2 to 10, in particular in a range from 2 to 5, very particularly preferably in a range from 2.75 to 4.75.

It goes without saying that in the case of a real shaped abrasive particle, deviations from an ideal or exact geometric body can occur as a result of the method of production. Depending on the production process and depending on the shaping method, differently strongly pronounced deviations occur. Thus, for example, rounding at the edges, corners and/or points in particular can occur as a result of the production process. Furthermore, one or more faces, for example a base area, top surface or side face, of the geometric body can have irregular unevennesses. These can, for example, be formed by air inclusions. Deformations can also occur as a result of, for example, a drying process.

Alpha-Al₂O₃ is used as starting material for the production of the ceramic abrasive particle of the invention. Alpha-Al₂O₃ is known per se to those skilled in the art and is commercially available, for example in powder form. For the purposes of the present invention, alpha-Al₂O₃ itself is thus employed as starting material. In particular, a precursor of alpha-Al₂O₃, for example boehmite (gamma-AlO (OH)), is not used as starting material.

ZrO₂ is additionally used as starting material for producing the ceramic abrasive particle of the invention. ZrO₂ is likewise known per se to those skilled in the art and is commercially available, for example in powder form.

For the present purposes, an average crystallite size is the grain size of the alpha-Al₂O₃ or ZrO₂ crystallite in the shaped ceramic abrasive particle. It has been found in the context of the present invention that a small average crystallite size achieves greater removal of material than a larger average crystallite size. Here, an average crystallite size means that an average is formed from a particular number of measured values for the crystallite size. The crystallite size can be determined by means of methods known per se, for example SEM or XRD analysis. For example, the images from an SEM analysis can be evaluated by means of the line intersection method. The line intersection method (also referred to as line method) is known per se to a person skilled in the art from microstructural analysis. Here, an average value of all measured intersection segment lengths is formed to determine the grain size. If appropriate, a correction factor can also be taken into account in determining the average.

In one embodiment, a ratio of the average crystallite size of the alpha-Al₂O₃ to the average crystallite size of the ZrO₂ is from 0.4 to 7.

In a further embodiment, the abrasive particle contains a stabilizer in a proportion of not more than 20% by weight in order to stabilize the ZrO₂, where the stabilizer is an oxide of the metals yttrium, magnesium, calcium or cerium or a mixture of two or more of these oxides. Suitable stabilizers are, in particular, Y₂O₃, CeO₂, MgO, CaO. Such a ZrO₂ is also referred to as stabilized ZrO₂. For example, a ZrO₂ stabilized with 3 mol % of Y₂O₃ is commercially available and is in commerce also known as 3Y-TZP. The stabilization makes the ZrO₂ remain in the tetragonal phase on cooling and not transform into the monoclinic phase. The stabilization can also make the ZrO₂ remain in the cubic phase on cooling and not transform into the tetragonal phase. On the other hand, if the ZrO₂ does not contain any stabilizer, it is also referred to as unstabilized ZrO₂. For the purposes of the present invention, the term stabilized ZrO₂ refers not only to a fully stabilized or essentially fully stabilized ZrO₂ but also a partially stabilized ZrO₂. For example, a partially stabilized transforms at least partially into the tetragonal phase on cooling. In particular, the ZrO₂ should be stabilized to at least such an extent that it does not transform, or at least does not transform completely, into the monoclinic phase on cooling.

Furthermore, the abrasive particle preferably contains MgO in a proportion of not more than 0.5% by weight, in particular from 0.02% by weight to 0.4% by weight. The MgO can, in particular, serve as means for inhibiting grain growth. MgO is known per se to those skilled in the art and is commercially available, for example in powder form.

The shaped ceramic abrasive particle preferably additionally contains SiO₂ in a proportion of from 0.01% by weight to 2% by weight, in particular from 0.015% by weight to 1% by weight, very particularly preferably from 0.02% by weight to 0.5% by weight. A small proportion of SiO₂ prevents or reduces, in particular, growth of very large grains in the microstructure and thus improves the abrasive performance.

In one embodiment, the shaped ceramic abrasive particle contains Na₂O in a proportion of from 0.01% by weight to 0.5% by weight, preferably from 0.015% by weight to 0.2% by weight. A small proportion of Na₂O can, in particular, prevent or restrict the growth of very large grains in the microstructure and thus improve the abrasive performance.

In one variant, the shaped ceramic abrasive particle contains CaO in a proportion of from 0.01% by weight to 0.03% by weight. A small proportion of CaO, too, can prevent or reduce, in particular, growth of very large grains in microstructure and thus improve the abrasive performance.

Furthermore, Fe₂O₃ is present in a proportion of from 0.01% by weight to 0.2% by weight in one variant of the shaped ceramic abrasive particle. A small proportion of Fe₂O₃ prevents or reduces, in particular, growth of very large grains in the microstructure and thus improves the abrasive performance.

The shaped ceramic abrasive particle has, in particular, a density which is from 92% to 99.9%, in particular from 96% to 99.9%, of the theoretical density. A high density brings about a greater strength of the abrasive particles and is associated with a smaller number of pores. The density of the abrasive particle can be determined by methods known per se, for example mercury porosimetry. It has been found that a large number of pores is undesirable. It is presumed here that when there is a large number of pores when grinding a workpiece using the shaped ceramic abrasive particle, rounding occurs at the cutting edges and metallic grinding dust is introduced into the pores.

The invention further provides an abrasive article which contains shaped ceramic abrasive particles based on alpha-Al₂O₃ with a proportion of ZrO₂ of from 5% by weight to 30% by weight, wherein the alpha-Al₂O₃ has an average crystallite size of from 0.5 μm to 3 μm and the ZrO₂ has an average crystallite size of from 0.25 μm to 8 μm.

In one variant of the abrasive article, unshaped, in particular broken, abrasive particles and/or partially shaped abrasive particles are also present in addition to the shaped ceramic abrasive particles. These unshaped abrasive particles and/or partially shaped abrasive particles serve, for example, as support particles. In this variant of the abrasive article, the proportion of shaped ceramic abrasive particles is, for example, not more than 80%, in particular from 50% to 80%, very particularly preferably from 60% to 70%, based on the total amount of abrasive particles. In contrast to shaped ceramic abrasive particles, unshaped ceramic abrasive particles do not have a defined geometry. They do not have any defined three-dimensional shape of defined size. In the production of such abrasive particles, no defined shaping process takes place. Unshaped abrasive particles have an irregular configuration and are randomly shaped. They can be produced by comminution, for example by crushing, with the comminution being carried out in a random manner so that the abrasive particles are formed by fragments. Such unshaped, in particular broken abrasive particles are adequately known to those skilled in the art. The production thereof is described, for example, in EP 947485 A1. In contrast to shaped ceramic abrasive particles, partially shaped ceramic abrasive particles do not have a completely defined geometry. Partially shaped abrasive particles sometimes have, in contrast to unshaped abrasive particles, a defined geometry having a partially defined three-dimensional shape of partially defined size. For example, partially shaped abrasive particles have at least one defined side face, in particular at least two defined side faces, and/or at least one defined edge, in particular at least two defined edges. Partially shaped abrasive particles have at least one randomly shaped side face and/or at least one randomly shaped edge. Such abrasive particles can, for example, be produced by firstly carrying out shaping to give a precursor and subsequently carrying out comminution of the precursor. Thus, for example, a layer having two essentially plane-parallel side faces can firstly be formed. This layer can subsequently be comminuted in a random manner, forming irregularly shaped fracture edges. Such partially shaped abrasive particles are, for example, described in DE 102015108812 A1.

Furthermore, the abrasive article in one variant also comprises single-phase shaped ceramic abrasive particles based on alpha-Al₂O₃ in addition to the two-phase shaped ceramic abrasive particles having a proportion of ZrO₂ of from 5% by weight to 30% by weight. For the purposes of the present invention, a single-phase abrasive particle is understood to mean an abrasive particle composed of alpha-Al₂O₃ with a proportion of ZrO₂ of essentially 0% by weight. A single-phase abrasive particle accordingly has essentially no proportion of ZrO₂. A single-phase abrasive particle is essentially free of ZrO₂. For the purposes of the present invention, the expression “free of” or “essentially free of” or “no proportion of” or “essentially no proportion of” means that a very small proportion of ZrO₂, for example as impurity, cannot be completely ruled out.

In this variant, the abrasive article comprises a mixture of two-phase shaped ceramic abrasive particles and single-phase shaped ceramic abrasive particles. Based on the total amount of shaped ceramic abrasive particles of such an abrasive article, the proportion of single-phase shaped ceramic abrasive particles is not more than 80%, in particular from greater than 0% to not more than 80%, very particularly preferably at least 5% and not more than 50%, relative to the proportion of two-phase shaped ceramic abrasive particles.

In a further variant of the abrasive article, unshaped, in particular broken, abrasive particles and/or partially shaped abrasive particles can also be present in addition to the two-phase and single-phase shaped ceramic abrasive particles. These unshaped or partially shaped abrasive particles act, for example, as support particles.

It has been found that an abrasive article comprising a mixture of single-phase shaped ceramic abrasive particles and two-phase shaped ceramic abrasive particles likewise provides an increased abrasive performance. Such an abrasive article has the advantage over an abrasive article comprising two-phase shaped abrasive particles without a proportion of single-phase shaped abrasive particles that the abrasive article is cheaper.

The abrasive article is, in particular, a coated abrasive article. The abrasive article comprises, in particular, a flexible substrate having at least one layer, in particular of paper, paperboard, vulcanized fiber, foam, a polymer, a textile structure, in particular a woven fabric, formed-loop knitted, drawn-loop knitted, braid, nonwoven, or a combination of these materials, in particular paper and woven fabric, in one or more layers. The flexible substrate gives the abrasive article specific properties in respect of adhesion, elongation, tear strength and tensile strength, flexibility and stability.

In a coated abrasive article, the abrasive particles adhere, in particular, by means of a base binder to the flexible substrate. The abrasive particles are, in particular, initially fixed in the desired position and distribution on the substrate by means of the base binder. Suitable base binders for applying abrasive particles to a flexible substrate are adequately known to a person skilled in the art from the prior art. Possible base binders are, in particular, synthetic resins, for example phenolic resin, epoxy resin, urea resin, melamine resin, polyester resin. In addition to the base binder, the abrasive article can have at least one covering binder, for example two covering binders. The covering binder or binders are, in particular, applied in layers to the base binder and the abrasive particles. The covering binder or binders in this case join the abrasive particles firmly to one another and firmly to the substrate. Suitable covering binders are also adequately known to a person skilled in the art from the prior art. Possible covering binders are, in particular, synthetic resins, for example phenolic resin, epoxy resin, urea resin, melamine resin, polyester resin. In addition, further binders and/or additives can be provided in order to give the abrasive article specific properties. Such binders and/or additives are well known to those skilled in the art.

Alternative abrasive articles, for example, bonded abrasive articles, are likewise possible. Bonded abrasive articles are, in particular, synthetic resin-bonded parting disks and grinding disks, with which a person skilled in the art is familiar. To produce synthetic resin-bonded parting disks and grinding disks, a composition is produced by mixing abrasive minerals and also fillers, pulverulent resin and liquid resin and this composition is then pressed to give parting disks and grinding disks having various thicknesses and diameters.

The abrasive article can be present in different manufactured forms, for example as abrasive disk or as abrasive strip, as sheet, roller or strip.

The invention also provides a process for producing shaped ceramic abrasive particles, which comprises the following steps:
a) Production of a slip from at least one alpha-Al₂O₃ powder, a ZrO₂ powder and a dispersion medium, with the slip having a solids content of from 50% by weight to 90% by weight and an average particle size of from 0.1 μm to 8 μm;
b) Introduction of the slip into depressions of a casting mold, with the depressions having a defined geometry;
c) Drying of the slip in the depressions to give abrasive particle precursors, with a solids content of the abrasive particle precursors being from 85% by weight to 99.9% by weight;
d) Removal of the abrasive particle precursors from the depressions;
e) Sintering of the abrasive particle precursors to give abrasive particles based on alpha-Al₂O₃ having a content of ZrO₂ of from 5% by weight to 30% by weight and a density of from 92% to 99.9% of the theoretical density, with the alpha-Al₂O₃ having an average crystallite size of from 0.5 μm to 3 μm and the ZrO₂ having an average crystallite size of from 0.25 μm to 8 μm.

The process of the invention is based on the slip process. In particular, the production of the shaped ceramic abrasive particles of the invention is not carried out by the sol-gel process which is adequately known from the literature. The individual process steps will be described in more detail below.

In step a) of the process of the invention, a slip is produced from at least one alpha-Al₂O₃ powder, a ZrO₂ powder and a dispersion medium. Water is particularly suitable as dispersion medium. Commercial alpha-Al₂O₃ powder and commercial ZrO₂ powder of the desired purity can be used for producing the slip. The production of the slip can, in particular, be carried out in a high-speed mixer.

The slip produced as per step a) has a solids content of from 50% by weight to 90% by weight and an average particle size of from 0.1 μm to 8 μm. The average particle size of the solids in the slip can be, in particular, from 0.1 μm to 4 μm, very particularly preferably from 0.1 μm to 2 μm and more particularly from 0.1 μm to 1 μm. It has been found that this small average particle size of the solids in the slip assists the formation of abrasive particles having a comparatively small average crystallite size. As already indicated at the outset, a comparatively small average crystallite size has an advantageous effect on the abrasive performance.

For the purposes of the present invention, an average particle size is understood to mean the D50 value of the particle size distribution, where the D50 value means that 50% of the particles are smaller than the value indicated. The description of a particle size distribution with the aid of D values (for example D10, D50, D90, D95, D99, D100) is adequately known to a person skilled in the art.

To achieve an average particle size of the solids in the slip of from 0.1 μm to 8 μm, step a) of the process can also comprise a milling operation. The milling operation is carried out in a mill, for example a ball mill. In particular, the milling operation can be carried out after dispersion of the pulverulent proportions of alpha-Al₂O₃ and of ZrO₂ in the dispersion medium.

In one embodiment of the process, a binder is added to the slip, especially in step a). Suitable binders are well known to those skilled in the art. For example, various polysaccharides and oligomers are particularly suitable. The finished slip contains, in particular, a proportion of binder of from 0.1% by weight to 2% by weight. The binder brings about a greater strength of the abrasive particle precursor, i.e. the unsintered abrasive particle, and thus assists handling, for example in the removal of the abrasive particle precursor from the casting mold.

In a further development of the process, a humectant is added to the slip, especially in step a). A suitable humectant is, in particular, glycerol. The finished slip contains, in particular, a proportion of humectant of from 0.2% by weight to 10% by weight, in particular from 0.5% by weight to 8% by weight, very particularly preferably from 1% by weight to 6% by weight. The humectant assists the later drying process in step c) and prevents the abrasive particle precursor from becoming too dry and therefore brittle.

Further additives can be added to the slip, especially in step a) of the process. For example, it is possible to add a dispersant. The amount of added dispersant is, for example, from 0.1% by weight to 2% by weight.

Furthermore, a wetting agent, for example a polyglycol ether, can be added. The amount of added wetting agent is, for example, from 0.05% by weight to 2% by weight from 0.1% by weight to 0.6% by weight.

In step b), the slip is introduced into depressions in a casting mold, with the depressions having a defined geometry. This process step serves to shape the slip to form shaped ceramic abrasive particles. In order to obtain shaped ceramic abrasive particles of defined geometry, the slip is introduced into depressions of defined geometry. The casting mold contains a plurality of depressions into which the slip is introduced. The depressions have a defined geometry which defines the geometry of the shaped ceramic abrasive particles. The depressions of defined geometry form the negative molds for the production of the shaped ceramic abrasive particle. For the purposes of the present invention, a defined geometry of the depressions is understood to mean a defined three-dimensional shape of defined size. The plurality of depressions in the casting mold all have, in particular, the same defined geometry in order to produce a plurality of shaped ceramic abrasive particles of the same geometry in one working step. As an alternative, the casting mold can also have depressions of different defined geometry in order to produce shaped ceramic abrasive particles of different geometry in one working step. The depressions are, in particular, provided on the upper side of the casting mold and are configured so as to be open in the direction of the upper side of the casting mold, so that the slip can be introduced into the depressions from above. The introduction can be carried out without applied pressure. Excess slip can, for example, be removed from the surface of the casting mold by means of a doctor blade. The casting mold can be made of a metal, for example aluminum, or of a polymer, for example silicone, polyurethane or polyvinyl chloride.

The drying of the slip as per step c) is preferably carried out at a temperature of from 25° C. to 60° C., in particular from 30° C. to 50° C. Drying is preferably carried out in a drying oven. During drying, at least part of the dispersion medium is removed. Drying takes, in particular, from 5 minutes to 4 hours, very particularly preferably from 20 minutes to 40 minutes. If drying is carried out at an excessively high temperature within a relatively short time, deformations of the abrasive particle precursors, which are generally undesirable in order to obtain abrasive particles of defined geometry, occur as a result of shrinkage. Abrasive particle precursors having a solids content of from 85% by weight to 99.9% by weight are formed by means of step c) of the process.

In a subsequent step d), the abrasive particle precursors are removed from the depressions. This process step of removing the abrasive particle precursors from the mold can be carried out in various ways. The abrasive particle precursors can, for example, be taken from the depressions by means of gravity. As an alternative or in addition, removal can be effected by bending the casting mold through a comparatively small radius. The removal can be assisted by additional assisting measures, for example brushing, compressed air, subatmospheric pressure and/or vibrations.

In step e), the abrasive particle precursors are sintered. The sintering of the abrasive particle precursors is carried out, in particular, at a temperature of from 1300° C. to 1700° C., in particular from 1450° C. to 1600° C. This forms abrasive particles based on alpha-Al₂O₃ having a content of ZrO₂ of from 5% by weight to 30% by weight and a density of from 92% to 99.9% of the theoretical density, with the alpha-Al₂O₃ having an average crystallite size of from 0.5 μm to 3 μm and the ZrO₂ having an average crystallite size of from 0.25 μm to 8 μm.

The invention also provides shaped ceramic abrasive particles which are produced by the process of the invention. Finally, the invention also provides an abrasive article which comprises shaped ceramic abrasive particles produced by the process of the invention.

### FIGURES

The invention is elucidated in more detail below with the aid of the figures. The figures show:

FIG. 1 a schematic view of one embodiment of the shaped ceramic abrasive particle of the invention;

FIG. 2 a section of a schematic sectional depiction of one embodiment of the abrasive article of the invention;

FIG. 3 a graph depicting the abrasive performance of the abrasive article of FIG. 2;

FIG. 4 a flow diagram depicting the process steps for producing the shaped ceramic abrasive particle.

FIG. 1 schematically depicts an illustrative embodiment of a shaped ceramic abrasive particle 10 according to the invention. The geometric shape of the abrasive particle 10 is formed by a regular three-sided right prism having the side edges 12 and the height 14. The base area 16 and the top surface 18 are accordingly each formed by three side edges 12 of equal length. The base area 16 and the top surface 18 are of equal size and are separated from one another by the height 14. The three side faces 17 are formed by rectangles and are equal in size. In the illustrative embodiment of FIG. 1, the side edges 12 have a length of 1400 μm. The height 14 is 410 μm. In an alternative embodiment, the length of the side edge 12 can also be 1330 μm and the height can be 14 400 μm.

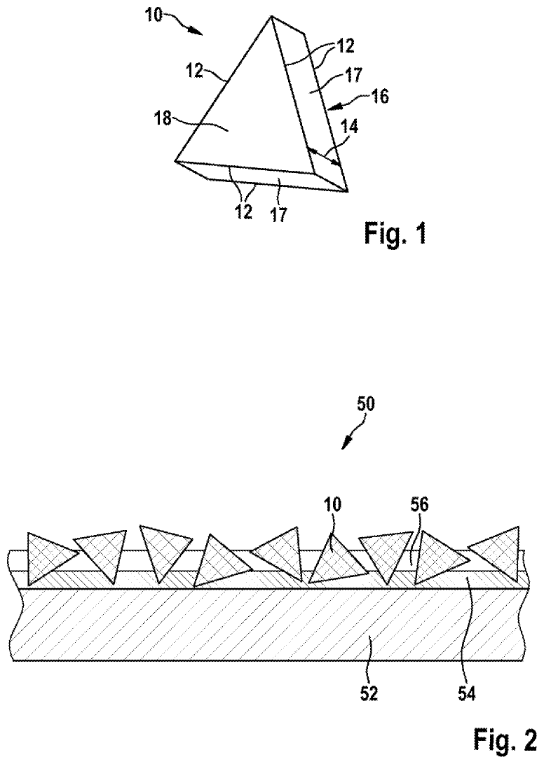

FIG. 2 shows a section of an illustrative embodiment of an abrasive article 50 according to the invention comprising abrasive particles 10 in a schematic sectional view. The abrasive article 50 in the embodiment depicted is a coated abrasive article 50 having a support element 52 made of vulcanized fiber. The support element 52 made of vulcanized fiber serves as flexible substrate for the abrasive particles 10. Vulcanized fiber is a composite material composed of cellulose, in particular cotton fibers or cellulose fibers, and is adequately known to a person skilled in the art from the prior art as flexible substrate for abrasive articles. The abrasive particles 10 are fastened to the support element 52 by means of a base binder 54, for example composed of phenolic resin. The layer of base binder 54 and abrasive particles 10 is coated with a covering binder 56, for example composed of phenolic resin.

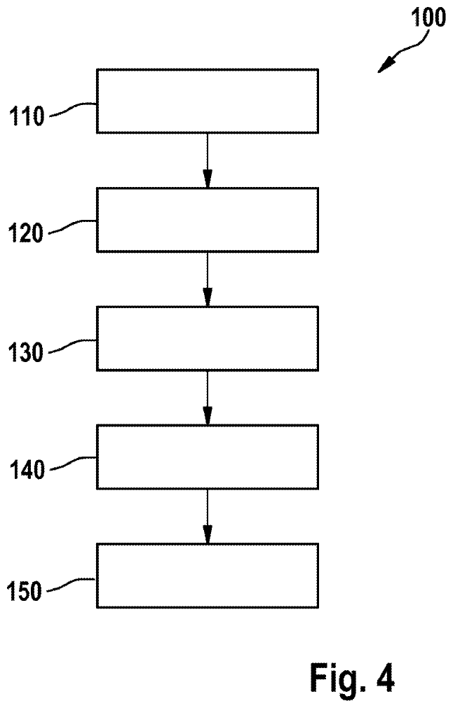

The process of the invention for producing shaped ceramic abrasive particles is explained in more detail in the flow diagram of FIG. 4. The production process 100 comprises the following steps: In a first step 110, a slip is produced from at least one alpha-Al₂O₃ powder, a ZrO₂ powder and a dispersion medium, with the slip having a solids content of from 50% by weight to 90% by weight and an average particle size of from 0.1 μm to 8 μm. In a second step 120, the slip is introduced into depressions of a casting mold, with the depressions having a defined geometry. Drying of the slip in the depressions is then carried out in a third step 130 to give abrasive particle precursors having a solids content of from 85% by weight to 99.9% by weight. After drying of the slip, the abrasive particle precursors are removed from the depressions in a fourth step 140. Furthermore, the abrasive particle precursors are sintered in a fifth step 150 to give abrasive particles based on alpha-Al₂O₃ having a content of ZrO₂ of from 5% by weight to 30% by weight and a density of from 92% to 99.9% of the theoretical density, with the alpha-Al₂O₃ having an average crystallite size of from 0.5 μm to 3 μm and the ZrO₂ having an average crystallite size of from 0.25 μm to 8 μm.

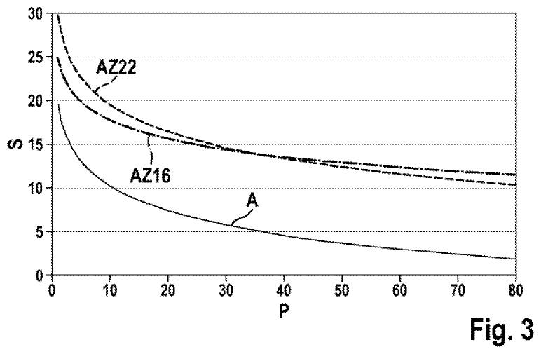

FIG. 3 shows in graph form the abrasive performance of different abrasive articles which have been produced using shaped ceramic abrasive particles having different proportions of ZrO₂. In the graph, the removal of material S measured in a grinding test in gram per plate is plotted on the y axis as measure of the abrasive performance, and the number of plates P which were ground in the grinding test is plotted on the x axis. A total of three grinding tests using three different examples of abrasive articles comprising shaped ceramic abrasive particles were carried out. In a first example according to the invention, an abrasive article comprising shaped ceramic abrasive particles having a proportion of ZrO₂ of 22% by weight was used (hereinafter also referred to as variant AZ22). In a second example according to the invention, an abrasive article comprising shaped ceramic abrasive particles having a proportion of ZrO₂ of 16% by weight was used (hereinafter also referred to as variant AZ16). In a third comparative example, an abrasive article comprising single-phase shaped ceramic abrasive particles which did not contain any ZrO₂ (0% by weight of ZrO₂) was used (hereinafter also referred to as variant A).

The abrasive particles of the variants AZ22, AZ16 and A were produced as follows. Firstly, a slip was produced (cf. FIG. 4, step 110) for each of the variants AZ22, AZ16 and A. For this purpose, the amounts of water as dispersion medium indicated in Table 1 and also Dolapix as dispersant were homogenized with the amounts indicated in Table 1 of pulverulent alpha-Al₂O₃, pulverulent ZrO₂ (for the variants AZ22, AZ16) and pulvulerent MgO in a high-speed mixer. The pulverulent ZrO₂ was partially stabilized ZrO₂ (ZrO₂ stabilized with 3 mol % of Y₂O₃). The further amounts indicated in Table 1 of the organic additives Optapix AC 112 as binder, Glydol N109 as wetting agent and glycerol as humectant were also added to the slip. The slip was subsequently milled in a ball mill. The finished slip had an average particle size of 0.2 μm.

TABLE 1

| | | | Comparative |
|---|---|---|---|
| Example | Example 1 | Example 2 | example |
| Variant | AZ22 | AZ16 | A |
| Water [g] | 18.8 | 18.8 | 18.5 |
| Al₂O₃ [g] | 57.9 | 62.4 | 74.2 |
| ZrO₂ [g] | 16.3 | 11.9 | 0 |
| MgO [mg] | 29 | 31 | 74 |
| Wetting agent | 0.6 | 0.6 | 0.6 |
| GLYDOL N 109 | | | |
| [g] | | | |
| Binder | 0.3 | 0.3 | 0.3 |
| OPTAPIX | | | |
| AC 112 [g] | | | |
| Humectant | 5.5 | 5.5 | 5.5 |
| Glycerol [g] | | | |
| Dispersant | 0.6 | 0.6 | 0.8 |
| DOLAPIX CE 64 | | | |
| [g] | | | |

The finished slip was, for each of the three variants AZ22, AZ16 and A, introduced in a subsequent step into depressions of a casting mold, with the depressions having a defined geometry (cf. FIG. 4, step 120). Introduction of the slip into the depressions was carried out manually by means of a manual doctor blade. The casting mold had the shape of a plate having a thickness of 3 mm and consisted of silicone. The casting mold had a plurality of depressions having the same geometry. In order to arrive at shaped ceramic abrasive particles as shown in FIG. 1, the depressions in the casting mold were configured as negative shapes of a regular three-sided right prism having an edge length of 1.7 mm and a depth of 0.5 mm.

In a further step, the slip in the depressions of the casting mold was dried (cf. FIG. 4, step 130). Drying was carried out at a temperature of 40° C. for a time of about 1 hour. This made it possible to obtain abrasive particle precursors having a solids content of, for example, 96% by weight.

After drying, the abrasive particle precursors were removed from the depressions of the casting mold (cf. FIG. 4, step 140). For this purpose, the casting mold was bent through a small radius. The removal from the mold was additionally assisted mechanically by means of a brush.

In a subsequent step, the abrasive particle precursors were sintered to give abrasive particles (cf. FIG. 4, step 150). Sintering was carried out at a temperature of 1530° C. for a time of 120 minutes for the variants AZ16 and AZ22 and at a temperature of 1560° C. for a time of 180 minutes for the variant A. After sintering, the abrasive particles had a density of 98% (variant AZ22), 97% (variant AZ16) and 95% (variant A95) of the theoretical density. The abrasive particles had a content of ZrO₂ of 16% by weight (variant AZ16, example 1 according to the invention), 22% by weight (variant AZ22, example 2 according to the invention) and 0% by weight (variant A, comparative example). In variant AZ22, the average crystallite size of the alpha-Al₂O₃ was 1.28 μm, while in the variant AZ16 the average crystallite size of the alpha-Al₂O₃ was 1.39 μm. The average crystallite size of the ZrO₂ was 0.61 μm in the variant AZ22 and 0.57 μm in the variant AZ16.

The respective abrasive articles 50 in the form of abrasive disks which were produced using the abrasive particles AZ22, AZ16 and A had the following structure (cf. FIG. 2). A fiber disk composed of vulcanized fiber and having a diameter of 180 mm and a thickness of 0.8 mm was used in each case as support element 52. A mixture of phenolic resin (35-50% by weight) and chalk (30-45% by weight) was used as base binder 54. Here, the amount of base binder used was 100-120 g/m² in the wet state. The amount of abrasive particles 10 which were applied to the support element 52 with base binder 54 was 640-740 g/m². As covering binder 56, a mixture of phenolic resin (20-30% by weight), chalk/kaolin mixture 1:1 (30-40% by weight) and cryolite (5-20% by weight) was used for variants AZ22 and AZ16. In the case of variant A, a mixture of phenolic resin (20-30% by weight), chalk (35-45% by weight) and cryolite (5-20% by weight) was used as covering binder 56. The amount of covering binder used was 760-950 g/m² in the moist state.

To determine the abrasive performance depicted in FIG. 3 of the respective abrasive articles produced using the abrasive particles AZ22, AZ16 and A, the following grinding test was carried out on a test stand. The respective abrasive article in the form of an abrasive disk was mounted on a support plate. As workpieces for grinding, use was made of steel plates composed of the materials 1.0332 and 1.8974 and having a machining area of 6 mm×285 mm. To determine the removal of material per steel plate, the steel plates were weighed before and after the grinding test. During the grinding test, the steel plates composed of the materials 1.0332 and 1.8974 were ground alternately. The respective abrasive disk was operated at a speed of rotation of 4181 rpm and the workpieces were moved past the abrasive disk at a rate of advance of 1.5 mm/s. During the test, the workpieces were pressed onto the abrasive disk under a weight of 6 kg. 80 steel plates were machined using each of the three abrasive disks having the abrasive particles AZ22, AZ16 and A.

The graph in FIG. 3 shows a significantly improved abrasive performance for the two abrasive particles AZ22 and AZ16 compared to the single-phase abrasive particle A. Furthermore, the graph shows an improved abrasive performance for the abrasive particle AZ22 compared to the abrasive particle AZ16 in a first phase of the grinding test (up to about 35 plates) and conversely an improved abrasive performance for the abrasive particle AZ16 compared to the abrasive particle AZ22 in a second phase of the grinding test (from about 35 plates to 80 plates). In the first phase of the grinding test, the removal by wear of the abrasive particles is lower than in the second phase (from about 35 plates to 80 plates).

1. A shaped ceramic abrasive particle based on alpha-Al₂O₃ comprising:
a ZrO₂ portion comprising from 5% by weight to 30% by weight of the abrasive particle,
wherein the alpha-Al₂O₃ has an average crystallite size of from 0.5 μm to 3 μm and the ZrO₂ has an average crystallite size of from 0.25 μm to 8 μm.

2. The shaped ceramic abrasive particle as claimed in claim 1, wherein the ZrO₂ portion comprises from 10% by weight to 25% by weight of the abrasive particle.

3. The shaped ceramic abrasive particle as claimed in claim 1, wherein a ratio of the average crystallite size of the alpha-Al₂O₃ to the average crystallite size of the ZrO₂ is from 0.4 to 7.

4. The shaped ceramic abrasive particle as claimed in claim 1, further comprising:
a stabilizer that stabilizes the ZrO₂, the stabilizer comprising less than or equal to 20% by weight of the abrasive particle,
wherein the stabilizer includes at least one of yttrium oxide, magnesium oxide, calcium oxide, and cerium oxide.

5. The shaped ceramic abrasive particle as claimed in claim 1, further comprising:
a MgO portion comprising less than or equal to 0.5% by weight of the abrasive particle.

6. The shaped ceramic abrasive particle as claimed in claim 1, further comprising:
a SiO₂ portion comprising from 0.01% by weight to 2% by weight of the abrasive particle.

7. The shaped ceramic abrasive particle as claimed in claim 1, further comprising:
a Na₂O portion comprising from 0.01% by weight to 0.5% by weight of the abrasive particle.

8. The shaped ceramic abrasive particle as claimed in claim 1, further comprising:
a CaO comprising from 0.01% by weight to 0.03% by weight of the abrasive particle.

9. The shaped ceramic abrasive particle as claimed in claim 1, further comprising:
a Fe₂O₃ comprising from 0.01% by weight to 0.2% by weight of the abrasive particle.

10. The shaped ceramic abrasive particle as claimed in claim 1, wherein a density of the abrasive particle is from 92% to 99.9% of a theoretical density of the abrasive particle.

11. An abrasive article comprising:
a plurality of first shaped ceramic abrasive particles, each particle of the plurality of first shaped ceramic abrasive particles being based on alpha-Al₂O₃ and having a ZrO₂ portion comprising from 5% by weight to 30% by weight of the abrasive particle, wherein the alpha-Al₂O₃ has an average crystallite size of from 0.5 μm to 3 μm and the ZrO₂ has an average crystallite size of from 0.25 μm to 8 μm.

12. The abrasive article as claimed in claim 11, further comprising:
a plurality of second shaped ceramic abrasive particles which are based on alpha-Al₂O₃ and are essentially free of ZrO₂,
wherein a proportion of second shaped ceramic abrasive particles being not more than 80%, of a total amount of shaped ceramic abrasive particles.

13. A process for producing shaped ceramic abrasive particles, comprising
producing a slip from at least one alpha-Al₂O₃ powder, a ZrO₂ powder, and a dispersion medium, the slip having a solids content of from 50% by weight to 90% by weight and an average particle size of from 0.1 μm to 8 μm;
introducing the slip into depressions of a casting mold, the depressions having a defined geometry;
drying the slip in the depressions to produce abrasive particle precursors, a solids content of the abrasive particle precursors being from 85% by weight to 99.9% by weight;
removing the abrasive particle precursors from the depressions;
sintering the abrasive particle precursors to produce the abrasive particles based on alpha-Al₂O₃ having a ZrO₂ portion comprising from 5% by weight to 30% by weight of the abrasive particle and a density of from 92% to 99.9% of a theoretical density, the alpha-Al₂O₃ of the abrasive particle having an average crystallite size of from 0.5 μm to 3 μm and the ZrO₂ of the abrasive particle having an average crystallite size of from 0.25 μm to 8 μm.

14. The process as claimed in claim 13, wherein the sintering of the abrasive particle precursors is carried out at a temperature of from 1300° C. to 1700° C.

15. The process as claimed in claim 13, wherein the drying of the slip is carried out at a temperature of from 25° C. to 60° C.

16. The process as claimed in claim 13, wherein the slip includes a humectant in a proportion of from 0.1% by weight to 10% by weight of the slip.

17-18. (canceled)

19. The shaped ceramic abrasive particle as claimed in claim 2, wherein the ZrO₂ portion comprises from 15% by weight to 22% by weight of the abrasive particle.

20. The shaped ceramic abrasive particle as claimed in claim 5, wherein the MgO portion comprises from 0.02% by weight to 0.4% by weight of the abrasive particle.

21. The shaped ceramic abrasive particle as claimed in claim 6, wherein the SiO₂ portion comprises from 0.02% by weight to 0.5% by weight of the abrasive particle.

22. The shaped ceramic abrasive particle as claimed in claim 7, wherein the Na₂O portion comprises from 0.015% by weight to 0.2% by weight of the abrasive particle.
